(19) United States
(12) Patent Application Publication
(10) Pub. No.: US 2007/0194087 A1
(43) Pub. Date: Aug. 23, 2007

(54) Welding electrode rating method using double cap pass test

(76) Inventors: Jonathan Sterling Ogborn, Concord, OH (US); Robert J. Weaver, Concord, OH (US); Craig B. Dallam, University Heights, OH (US); Randall M. Burt, Medina, OH (US)

Correspondence Address: FAY SHARPE / LINCOLN, 1100 SUPERIOR AVENUE, SEVENTH FLOOR, CLEVELAND, OH, 44114, US

(21) Appl. No.: 11/360,901

(22) Filed: Feb. 23, 2006

(51) Int. Cl. B23K 31/12

(52) U.S. Cl. 228/103

(57) ABSTRACT

Methods for rating welding electrodes are presented, in which a standardized vertical-down double cap pass welding procedure is performed using a test electrode to create a test weld on a substantially flat workpiece surface, and the electrode is rated according to the amount of porosity in the test weld. A first vertical-down bead-on-plate welding operation is performed to create a substantially straight first weld bead on the workpiece surface, followed by a standardized moderate first slag removal operation to expose an upper portion of the first bead while leaving some slag along one or both longitudinal sides of the first weld bead. A standardized second vertical-down welding operation is then performed with the test electrode to cover the first weld, and another slag removal operation is used to remove any remaining slag. The test electrode is then rated according to the ratio of the number of visually discernable pores in the second weld bead divided by the test weld length.

### FIELD OF THE INVENTION

The present invention relates generally to arc welding technology, and more particularly to methods for rating welding electrodes with respect to weld porosity.

### BACKGROUND OF THE INVENTION

In the manufacture of pipelines for transporting petroleum products or other fluids, pipe welding techniques are used to join the longitudinal ends of generally cylindrical pipe sections to form an elongated pipeline structure with an interior suitable for transporting gases or liquids. In a typical situation, stick welding is used to weld the welding pipe sections together to form pipelines, wherein cellulosic and other types of stick welding electrodes are commonly employed for these applications. Initially, two pipe sections are axially aligned with beveled ends thereof proximate one another to define a narrow gap and the pipe ends are joined using an initial root pass weld to form a root bead that fills the gap. One or more stick weld filler passes are performed to fill the pipe joint groove, with the final pass forming a cap on the weld joint, referred to as a cap pass. Because weld material from the initial filler passes accumulates to the point of virtually filling the gap, the final cap pass is largely unprotected from atmospheric effects. As a result, the cap pass is particularly susceptible to porosity, which if present, can weaken the weld joint.

Porosity generally refers to pores or holes that are evident on the surface of a weld following slag removal, where such pores are generally undesirable, particularly in the cap pass of a pipe welding operation. Porosity is the result of trapped gas in the weld metal, and may be caused by a variety of factors, including the presence of contaminants in the weld joint. Although cleaning the exterior surfaces of the pipe ends may alleviate porosity to a certain extent, the composition and cleanliness of the welding electrode and the welding process parameters also have an impact on porosity. With regard to contaminants, stick welding electrodes sometimes become rusty, or may become contaminated with oil, grease, or dirt during storage, which may increase the likelihood of porosity in a finished pipe welding cap pass. Also, if an inadequate amount of flux is present during welding, the welding arc can cause scattered surface porosity, where variations in the amount of flux are prevalent in circumferential welds such as pipe welding, particularly at the vertical-down portions of a circumferential weld (e.g., 3:00 and 9:00 positions). With respect to pipe welding, there is no mechanical flux or slag containment structure in the final cap pass due to the lack of sidewall protection, wherein the cap pass weld may contain, surface porosity or other defects caused by flux or slag spilling off the weld prior to solidification. In this regard, the metal and slag can spill or can interfere with the operation of the welding electrode. Another factor is the welding current amplitude and polarity, where positive polarity DC current (electrode positive with respect to the weld pool) provides higher penetration with lower porosity, while reverse polarity provides for higher deposition rates with higher likelihood of porosity. The base metal composition, and particularly the degree of local segregation of constituent materials, may also affect porosity. For instance, sulfur may tend to segregate within steel alloys and lead to large holes in the weld. Other welding process parameters may also enhance or inhibit porosity. For example, fast welding speeds may increase arc blow and therefore increase the chance of porosity, whereas slow welding translation speeds may tend to facilitate gas escaping through the molten pool prior to slag solidification, although reducing speed without reducing weld metal deposition rate may not be possible due to weld metal spill out, and with reducing deposition rate generally increases costs. In addition, slag remaining from a previous weld pass may increase porosity.

The electrode material composition also has an impact on the finished weld porosity. In particular, organic electrode materials tend to burn during welding, thereby producing gas bubbles or pockets within the molten weld material. Cellulosic stick welding electrodes are sometimes preferred in pipe welding operations, and include hydrogen based constituents that tend to ignite during welding, creating gases that become trapped in the weld material and eventually create pores or holes in the solidified weld. Another factor that may influence weld porosity is moisture in the coating for stick electrodes, where higher moisture content is believed to reduce porosity and vice versa. Moreover, porosity is a problem in other welding processes, such as self-shielded operations using flux cored electrodes (e.g., self-shielded flux cored arc welding or FCAW-S processes). While various steps can be taken to mitigate porosity by careful selection of welding operation settings and welding operations and/or by reducing the amount of external contaminants, there remains a need for techniques by which cellulosic and other stick welding electrodes as well as flux-cored electrodes can be characterized or rated according to the propensity for final weld porosity to facilitate objective selection of suitable electrodes for use in a given welding application, as well as to facilitate quality control in the manufacture of welding electrodes.

### SUMMARY OF INVENTION

A summary of one or more aspects of the invention is now presented in order to facilitate a basic understanding thereof, wherein the summary is not an extensive overview of the invention, and is intended neither to identify certain elements of the invention, nor to delineate the scope of the invention. Rather, the primary purpose of the summary is to present some concepts of the invention in a simplified form prior to the more detailed description that is presented hereinafter. The present invention provides methods for rating the performance capabilities of welding electrodes, such as cellulosic stick electrodes, flux-cored electrodes, or other welding electrode types for various welding operations, such as for pipe welding, with respect to porosity. A double cap pass test is performed with the tested electrode, where the test is designed to encourage formation of gas bubbles within the molten test weld so as to provide an objective measure of the propensity of a tested electrode to cause porosity in the final weld, whereby a certain electrode type can be rated and/or two or more electrodes can be objectively ranked or compared with respect to porosity performance. The standardized testing and objective rating can be advantageously employed in determining whether a particular electrode is suitable for use in a particular pipe or other welding operation to avoid or mitigate porosity, wherein the rating for a known acceptable electrode can be compared with that of a proposed substitute. Moreover, the rating methods of the invention are particularly useful in objectively quantifying the relative performance of new improved electrode designs compared with inferior brands. In addition, the various aspects of the invention may be employed in manufacturing quality control applications, wherein sample electrodes may be tested and rated to ascertain whether a particular electrode fabrication process is experiencing variations in production parameters, material quality, etc.

In accordance with one or more aspects of the invention, a method is provided for rating welding electrodes, in which a test electrode, such as a cellulosic stick electrode, flux-cored electrode, etc., is provided along with a workpiece having a substantially flat surface. The workpiece is oriented such that the flat surface is substantially vertical, and a standardized vertical-down double cap pass welding procedure is performed using the test electrode to create a test weld extending along a longitudinal direction on the workpiece surface. The tested electrode is then rated based on the number of visible pores in the double cap test weld and according to the test weld length, for instance, as the number of pores per unit length. In general, the double cap pass procedure is standardized such that the procedure can be repeated to provide objectively comparable results when testing identical electrodes and which provides results that can be reliably differentiated for different electrodes with respect to finished weld porosity. In addition, the standardized weld procedure can be designed in one or more respects to promote the creation of pores in the finished test weld, so as to allow precise repeatable differentiation between similar electrodes, by which an informed decision can be made as to which electrode is superior regarding minimization of porosity. Furthermore, the test can be tailored to emulate a particular welding process of interest and/or one or more worst case aspects thereof with respect to porosity. For instance, the test may be designed to differentiate the porosity performance characteristics of electrodes used in cap pass pipe welding situations, by which the resulting electrode test ratings may be correlated to electrode performance in real-life applications.

In one exemplary embodiment, the double cap pass welding procedure includes forming a substantially straight first bead of about six inches or more in length via a standardized first vertical-down bead-on-plate (BOP) welding operation using the test electrode, where the first bead is preferably formed about an inch or more away from a nearest edge of the workpiece. The use of a bead-on-plate first test weld creates a bead protruding outward from the otherwise flat workpiece surface, which in certain respects emulates a pipe joint after successive filler weld passes have substantially filled the welding gap, whereby a subsequent cap pass is formed with essentially little or no sidewall protection. In this manner, a second cap pass weld performed in the test is done under similar conditions relative to a pipe welding cap pass weld. Moreover, the use of a vertical-down weld simulates the worst case portion of a circumferential pipe weld application. In addition, the standardized first vertical-down bead-on-plate (BOP) welding operation may be designed (e.g., by suitable polarity and/or current level selection) to controllably and repeatably create a first bead having relatively pronounced corners at the longitudinal weld edges or toes, where the corners promote porosity in a subsequent second cap pass test weld. After the first bead is created, a moderate controlled slag removal operation is performed to expose an upper portion of the first weld bead, which may also leave some slag remaining along at least one longitudinal side of the first weld bead (e.g., in the corners of the first bead). In this implementation, the corner geometry and the remaining slag cooperatively enhance the propensity for pore formation in the subsequent cap pass.

Following the first (moderate) slag removal operation, a standardized second vertical-down welding operation is performed using the test electrode to create a second weld bead extending over the first weld bead and over the remaining first slag, where the second weld itself creates a second slag on the outer surface of the second weld bead. In order to determine the extent to which the electrode may be susceptible to porosity, the second welding operation is preferably performed by weaving the test electrode laterally to create a serpentine second weld bead that extends laterally so as to cover the longitudinal edges of the first weld (past the corners and remaining first slag), wherein the outer portions of the second weld will be more likely to include pores than the center. Thereafter, the second slag is removed to expose the finished second weld bead and any discernable pores thereof for visual inspection. The tested electrode is then rated according to the number of visible pores as well as the test weld length, such as by determining the ratio of the number of pores divided by the test weld length.

### BRIEF DESCRIPTION OF THE DRAWINGS

The following description and drawings set forth in detail certain illustrative implementations of the invention, which are indicative of several exemplary ways in which the principles of the invention may be carried out. Various objects, advantages and novel features of the invention will become apparent from the following detailed description of the invention when considered in conjunction with the drawings, in which:

FIG. 1 is a flow diagram illustrating an exemplary method of rating a welding electrode with respect to porosity, in which a standardized vertical-down double cap pass welding procedure is performed and the tested electrode is rated according to the amount of porosity in the resulting test weld in accordance with one or more aspects of the present invention;

FIG. 2 is a detailed a flow diagram illustrating an exemplary standardized vertical-down double cap pass welding procedure in the method of FIG. 1, including a first vertical-down bead-on-plate welding operation, a standardized moderate first slag removal operation, a standardized second vertical-down welding operation, and a final slag removal operation;

FIG. 3 is a perspective view illustrating an exemplary test workpiece suitable for use in performing the methods of the invention;

FIG. 4 is a perspective view illustrating an exemplary cellulosic stick welding electrode that may be tested and rated according to the methods of the invention;

FIG. 5 is a partial side elevation view in section illustrating a standardized first vertical-down bead-on-plate welding operation in the method of FIGS. 1 and 2 using a stick test electrode;

FIGS. 6A and 6B are partial top plan views in section taken along lines 6A-6A and 6B-6B in FIG. 5 illustrating formation of an exemplary first weld bead on a flat surface of the workpiece of FIG. 3 using the first vertical-down bead-on-plate welding operation;

FIG. 6C is a frontal elevation view taken along line 6C-6C in FIG. 5 illustrating the finished first weld bead covered with first slag following the first vertical-down bead-on-plate welding operation;

FIG. 7A is a partial top plan view in section illustrating a moderate first slag removal operation performed to expose an upper portion of the first weld bead while leaving remnants of the first slag along side edges of the first weld bead;

FIGS. 7B and 7C are sectional top plan and frontal elevation views, respectively, illustrating the first weld bead following the moderate slag removal operation with a portion of the first slag remaining along the longitudinal edges of the first weld bead;

FIG. 8A is a partial top plan view in section illustrating a second vertical-down welding operation in which the test electrode is weaved laterally to create a serpentine second weld bead extending over the first bead;

FIGS. 8B and 8C are sectional top plan and frontal elevation views, respectively, illustrating the workpiece after the second vertical-down welding operation, with a second slag solidified over the second weld bead;

FIG. 9A is a partial top plan view in section illustrating a second slag removal operation performed to remove the second slag and expose the second weld bead;

FIGS. 9B and 9C are sectional top plan and frontal elevation views, respectively, illustrating the exposed second weld bead with visible pores;

FIG. 10 is a plot illustrating several exemplary acceptance criteria curves for the number of visible pores per unit length;

FIGS. 11A-11C are frontal elevation views illustrating workpieces with exemplary test welds with no visible pores, an acceptable number of pores, and an unacceptably large number of pores, respectively;

FIG. 12 is a partial side elevation view in section illustrating a standardized first vertical-down bead-on-plate welding operation using a solid or cored electrode in accordance with the invention;

FIG. 13A is sectional end view taken along line 13-13 in FIG. 12 illustrating an exemplary solid electrode that may be tested and rated according to the methods of the invention; and

FIG. 13B is another sectional view taken along line 13-13 in FIG. 12 illustrating an exemplary cored electrode that may be tested and rated according to the methods of the invention.

### DETAILED DESCRIPTION OF THE INVENTION

One or more exemplary implementations of the invention are described hereinafter in conjunction with the drawings, wherein like reference numerals are used to refer to like elements throughout and wherein the illustrated structures are not necessarily drawn to scale. The invention relates to evaluating or rating welding electrodes using a standardized vertical-down double cap pass welding procedure to ascertain a measure of the tested electrode's porosity performance, wherein the double cap pass procedure may be tailored or designed to simulate the effects of welding a cap pass on a pipe weld in extreme conditions that tend to promote porosity. However, the various aspects of the invention are not limited to testing with respect to pipe welding applications and may be used to characterize a stick electrode's porosity performance for any given application. Furthermore, the invention finds utility in rating any type of electrode, including but not limited to the exemplary cellulosic and other type of stick welding electrodes, solid, and cored electrodes described herein.

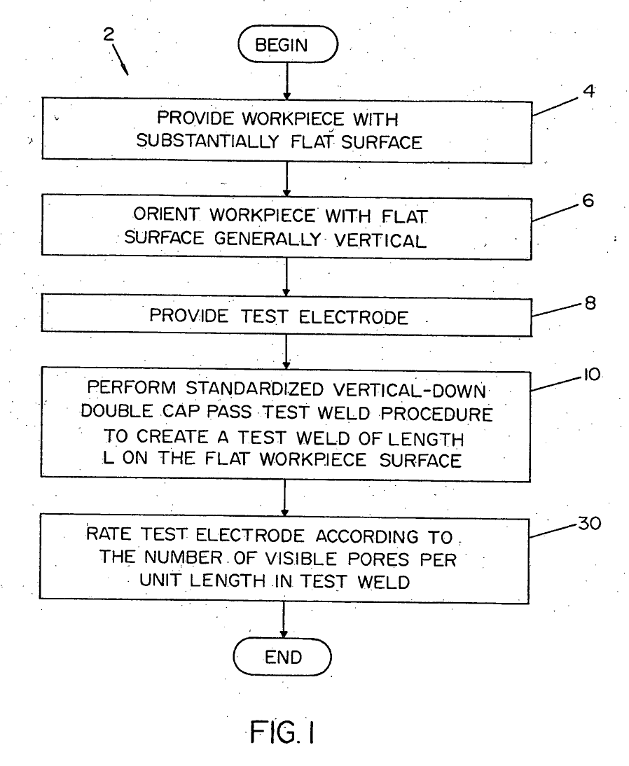

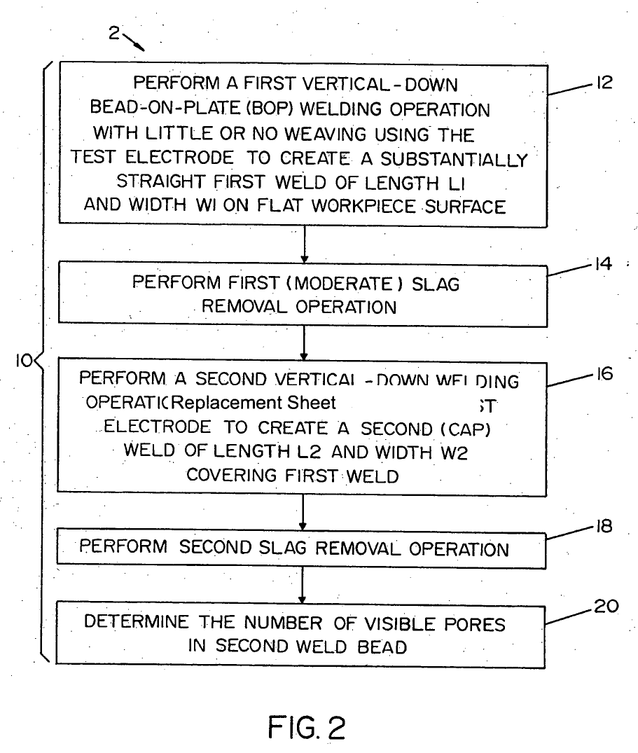

Referring initially to FIGS. 1-5, FIG. 1 illustrates an exemplary method 2 for rating a tested electrode with respect to porosity in accordance with the present invention and FIG. 2 illustrates one possible standardized vertical-down double cap pass welding procedure 10 that may be employed in the method 2 of FIG. 1. The exemplary process or method 2 is illustrated and described below as a series of acts or events. However, the methods of the present invention are not limited by the illustrated ordering of such acts or events. For example, some acts may occur in different orders and/or concurrently with other acts or events apart from those illustrated and/or described herein, in accordance with the invention. In addition, not all illustrated steps may be required to implement a methodology in accordance with the present invention. Moreover, the methods of the invention may be carried out in conjunction with various welders, welding electrodes, systems, and workpieces illustrated and described herein, as well as in association with other structures, systems, or electrodes that are not illustrated or specifically discussed.

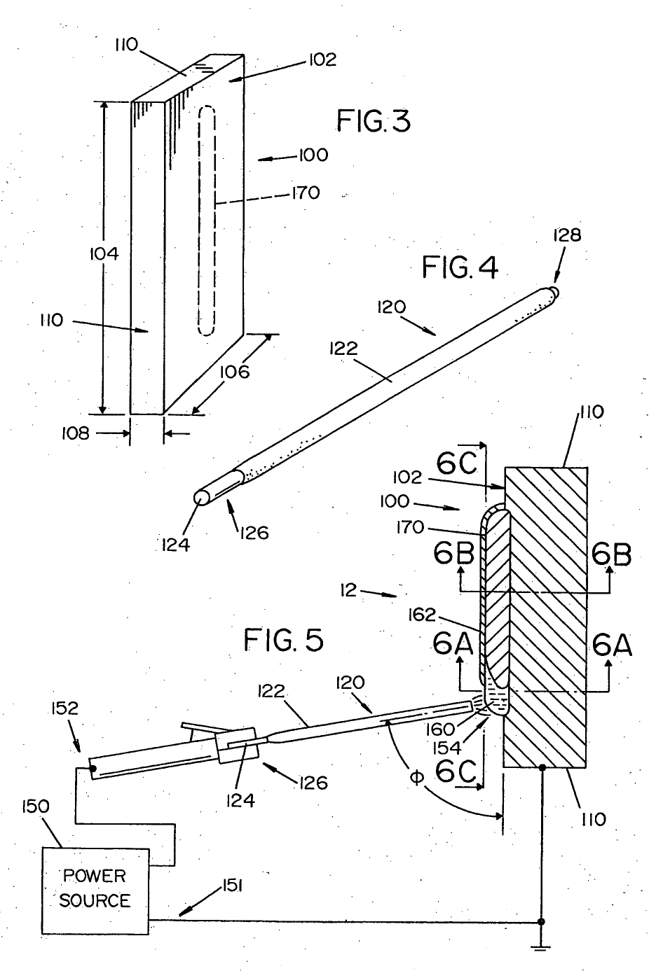

Beginning at 4 in FIG. 1, method 2 includes providing a workpiece having a substantially flat surface, and orienting the workpiece with the flat surface generally upright or vertical at 6. FIG. 3 illustrates an exemplary workpiece 100 suitable for use in the methods of the invention, where workpiece 100 is a steel plate structure with a longitudinal length 104, a width 106, and a thickness 108 having a flat front surface 102 and sides or edges 110. In practice, the flat workpiece surface 102 need not be strictly planar or exactly vertical, and may be within 5 or 10 degrees of strictly vertical for performance of a vertical-down welding operation. Any workpiece 100 may be used in performing the tests of the invention that is formed of a material suitable for bead-on-plate (BOP) welding operations using welding electrodes of interest, and the workpiece 100 may be of any suitable dimensions 104, 106, and 108 allowing vertical-down welding on front face 102. In the illustrated example, the workpiece length 104 is greater than about 8 inches and the width 106 is about three inches or more to allow a double cap pass test weld having a longitudinal length of about 6 inches or more to be created on surface 102 without the test weld extending closer than one inch from any of the plate edges 110. Furthermore, the workpiece material may, but need not, be selected to closely approximate that of a welding application of interest, for instance, that of pipe sections being joined by pipe welding.

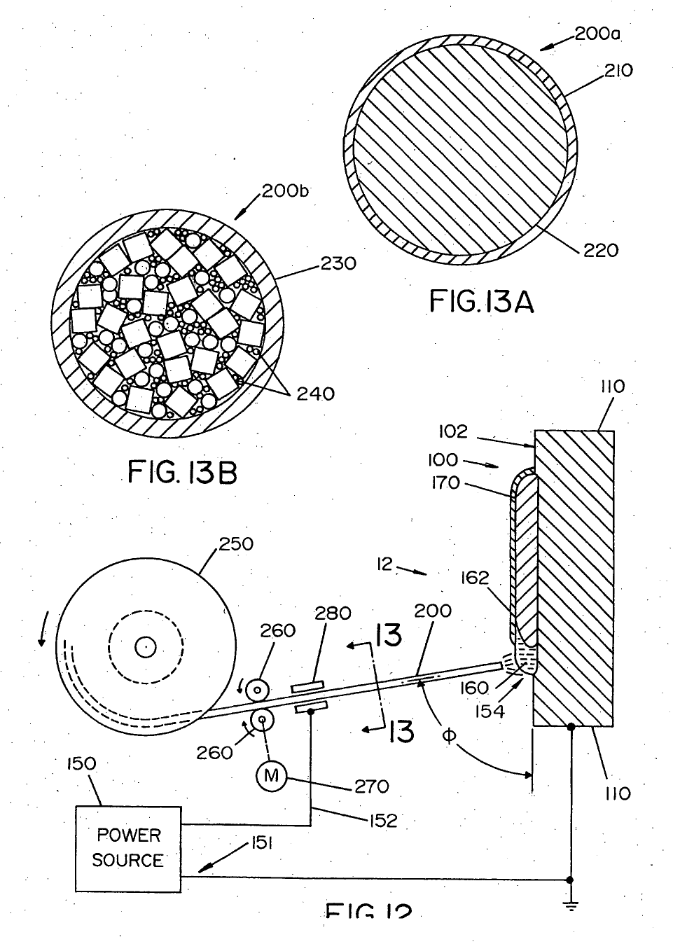

A test electrode is provided at 8 in FIG. 1 to be rated according to porosity performance. As illustrated in FIG. 4, a coated cellulosic stick welding electrode 120 is used in one preferred example, although this is not a strict requirement of the invention. As discussed below in connection with FIGS. 12, 13A, and 13B, moreover, any type of welding electrode may be evaluated and rated according to the concepts of the invention, including but not limited to cellulosic and other stick electrodes, solid core electrodes (e.g., electrode 200a in FIG. 13A below), metal cored electrodes (FIG. 13B), flux-cored electrodes (FIG. 13B), or other cored electrodes having both fluxing and alloying components in a central core surrounded by a metal sheath structure, wherein such are collectively referred to as cored electrodes. In the illustrated stick electrode implementation, the electrode 120 in FIG. 4 includes an outer coating 122 surrounding a solid metallic inner core 124, where coating 122 may include binding materials, flux materials, alloying agents, and organic material such as cellulose (wood powder), particularly for pipe welding applications. In this regard, conventional pipe welding stick electrodes having acceptable porosity performance include approximately 3% to 8% moisture or less by weight of the electrode coating 122. In general, the cellulosic coating materials 122 tend to create gas during welding and thus discourage formation of pores in the finished weld, wherein increased moisture content is believed to reduce porosity. Electrode 120 includes a hold end 126 with an uncoated section of core electrode 124 for electrical connection to a power source cable clamp 152 as shown in FIG. 5 below, as well as a strike end 128 ground to remove coating 122 from a portion thereof to facilitate arc starting. At 10 in FIG. 1, a standardized vertical-down double cap pass welding procedure is performed using electrode 120 to create a test weld of length L extending along a longitudinal direction on surface 102 of workpiece 100. Details of one suitable double cap pass welding procedure 10 are illustrated and described further below with respect to FIG. 2, although any double cap pass welding procedure can be used within the scope of the invention. Test electrode 120 is then rated at 30 according to a number of visible pores in the test weld and according to the length of the test weld. In the illustrated implementation, the rating is computed as a ratio of the number of pores visible in the finished test weld divided by the length of the test weld.

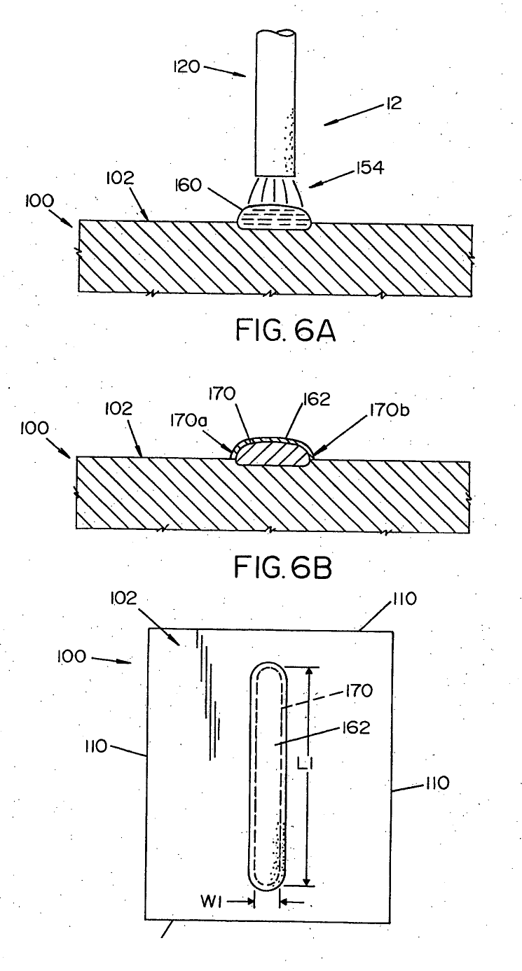

Referring now to FIGS. 2 and 5-9C, the exemplary double cap pass welding procedure 10 is further illustrated in FIG. 2, and FIG. 5 illustrates a suitable vertical-down bead-on-plate welding system in which the procedure 10 may be carried out, including a power source 150 with a first (grounded) output terminal 151 coupled to workpiece 100 and a second output with a clamp 152 electrically connected to hold end 126 of electrode 120. In operation, provision of a welding signal voltage between terminals 151 and 152 provides a current and resulting welding arc 154 between electrode 120 and workpiece 100. Welding arc 154 melts the end of electrode 120 as well as a portion of workpiece surface 102, causing creation of molten weld material 160 on surface 102, along with first slag 162 that solidifies over molten material 160 and a resulting solidified first weld bead 170. A first vertical-down bead-on-plate welding operation is performed at 12 in FIG. 2 to create a first weld bead 170 on surface 102, where first weld operation 12 can be any standardized operation that is repeatable to provide a substantially straight first bead 170, preferably without any lateral weaving of electrode 120. In one suitable implementation, a substantially straight first bead 170 is created having a first length L1 of about six inches or more via operation 12 with bead 170 being formed about an inch or more away from a nearest workpiece edge 110 with a width W1 (FIG. 6C) approximately twice the electrode diameter. Electrode 120 is maintained at a relatively constant angle φ relative to the generally vertical workpiece surface 102 during the exemplary operation 12, although this is not a strict requirement of the invention. The welding parameters of the standardized operation 12 may be selected to provide a controlled amount of weld penetration into surface 102 and a repeatable corner profile along longitudinal sides of weld bead 170. In one example using a 3/16” (4.8 mm) cellulosic electrode 120, a reverse DC welding current of about 150 to 170 amps is employed (with the electrode terminal 152 at a lower voltage potential than the first (grounded) terminal 151) in the first vertical-down welding operation 12 with little or no lateral weaving to controllably and repeatably create first bead 170 having relatively pronounced corners 170a, 170b (FIG. 6B) at the longitudinal weld edges. Once the first weld 170 has cooled, first slag 162 remains on the outer surface of bead 170, and in particular, remains in the corners 170a, 170b along the longitudinal bead edges.

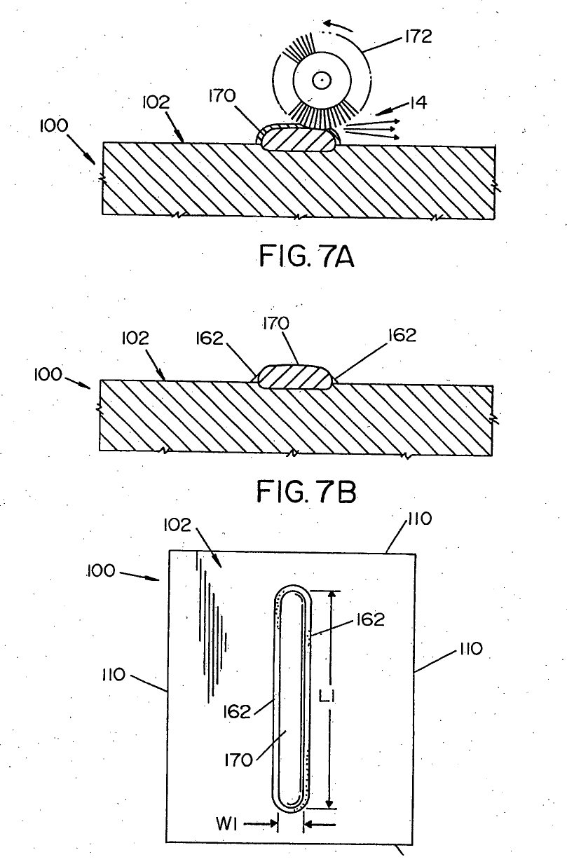

After the first weld bead 170 has cooled, a standardized first slag removal operation is performed at 14 (FIGS. 2 and 7A) to expose an upper portion of first weld bead 170 while leaving some of the first slag 162 remaining along one or both longitudinal sides of the first weld bead 170 (FIGS. 7B and 7C). Any suitable slag removal operation can be employed within the scope of the invention, wherein one suitable example is shown in FIG. 7A, in which a grinder or power brush 172 is operated at moderate settings to remove the upper first slag 162 without disturbing the slag 162 in the corners 170a, 170b. In another possible implementation, the slag removal can be performed by scraping the slag, for example, by using a hammer in a controlled and repeatable manner. In this regard, the shape of the weld bead corners 170a, 170b and the remaining slag 162 remaining therein tend to promote porosity in a subsequent second cap pass test weld. The slag removal operation 14 is preferably automated or otherwise repeatable, such that the amount of slag 162 removed and the amount of remaining slag 162 are generally the same when a number of tests are performed. It is noted in FIGS. 6A-6C that the first welding operation 12 and the first slag removal operation provide a structure over which a subsequent second or cap pass may be formed, where the structure in FIGS. 7B and 7C is conducive to porosity and generally emulates a final cap pass in a pipe welding situation with no sidewall protection. Furthermore, the parameters used in forming the first weld bead 170 can be tailored to provide a controlled amount of bead width W1 and penetration, for instance, by controlling the welding current setting, the welding angle φ, lineal weld speed, arc length, etc., such that a controllable corner profile and amount of remaining first slag 162 can be achieved in a repeatable fashion.

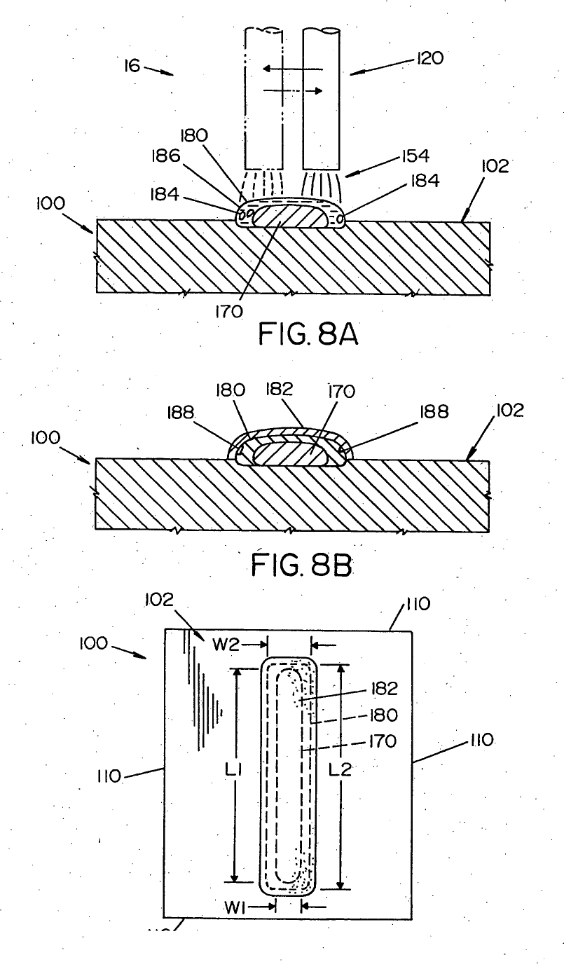

Referring also to FIGS. 2 and 8A-8C, a standardized second vertical-down welding operation is performed at 16 using the same test electrode 120 (or another electrode 120 of the same type and manufacturing lot) to create a second weld bead 180 of length L2 and width W2 extending over the first weld bead 170 and over any remaining first slag 162 in the corners of the first bead 170, where the operation 16 also creates a second slag 182 on an outer surface of the second weld bead 180. In a preferred implementation, the second vertical-down weld operation 16 includes weaving, wherein electrode 120 is translated or weaved laterally as best shown in FIG. 8A to create the second weld bead 180 as a serpentine bead extending laterally beyond the sides of first bead 170. As discussed above, the corners of first bead 170 and the first slag 162 initially remaining therein tend to promote formation of pockets or bubbles 184 within the molten second weld material 186 in FIG. 8A, typically through cellulose electrode components igniting and forming gas pockets 184 during welding operation 16. As shown in FIG. 8B, moreover, a certain amount of the pockets 184 within molten material 186 may rise to the surface of the molten material and be trapped at the surface by solidified slag 182, thereby forming pores 188. Second bead 180 typically will extend to a length L2 of about 6 inches or more and will have a width W2 at least as wide as width W1 of first bead 170. As shown in FIG. 8C, once the second welding operation 16 is completed, second slag 182 remains covering the second weld bead 180 and any pores 188 therein.

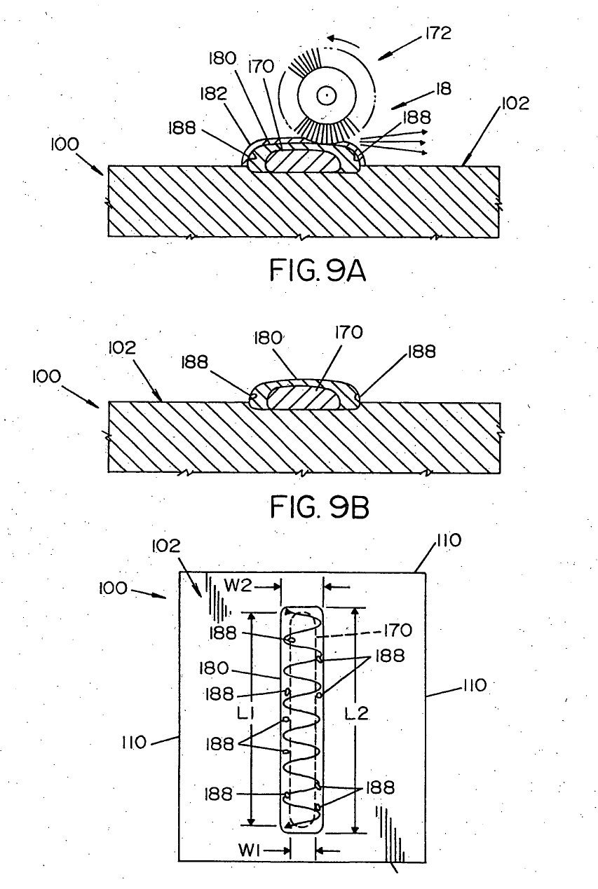

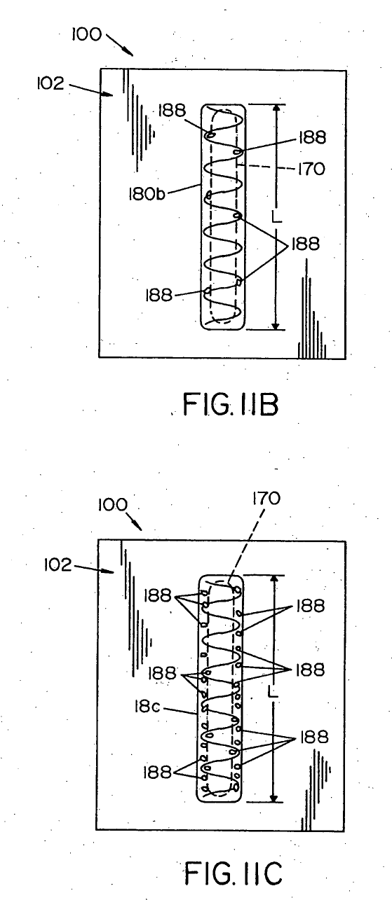

A standardized second slag removal operation is then undertaken at 18 (FIG. 2), as best illustrated in FIG. 9A, to remove substantially all of the second slag 182, thereby exposing outer surface of second weld bead 180 and any pores 188 therein. The second slag removal operation 18 can be any suitable material removal operation, for example, using power brush or grinder 172 (or a hammer or other-repeatable scraping technique and tools), that tends to remove all or substantially all of the second slag 182 without significantly impacting second weld bead 180, and by which any surface pores 188 in weld 180 are exposed to ordinary visual inspection of weld 180. FIGS. 9B and 9C show workpiece 100 following the second slag removal 18, in which one or more of the weld pores 188 are visibly discernable using unassisted visual inspection. In the illustrated case of FIGS. 9B and 9C, it is seen that the tested electrode 120 is susceptible to porosity in the second cap pass, where the susceptibility is accentuated to a certain degree by virtue of the vertical-down nature of operation 16, the extent and shape of corners 170a and 170b (FIG. 6B above) in the underlying first weld bead 170, the amount (if any) or remaining first slag 162 in the corners, the welding parameters employed in the operation 16, and the porosity propensities of electrode 120 itself. In this regard, the second vertical-down welding operation 16 is standardized such that apart from the electrode characteristics, the above factors are controlled and repeatable such that the amount of porosity in finished second (cap) weld 180 is indicative of the porosity performance of the tested electrode 120, whereby a rating can be established that correlates to the performance of tested electrode 120, and ratings of two different electrodes will be useable to distinguish between electrodes having different characteristics with regard to porosity. It is further noted in FIG. 9C as well as FIGS. 11B and 11C below, that the pores 188 will tend to be formed (if at all) near the edges of the finished second weld bead 180 because of the first bead corners and remaining first slag 172 thereat during the second weld operation 16.

Once the second slag 182 has been removed, the number of visible pores 188 in the second weld bead 180 is determined at 20 (FIG. 2), wherein any suitable visual inspection technique or automated optical inspection can be performed at 20 within the scope of the invention, by which the number of pores 188 of a given minimal size (e.g., visually discernable to the naked eye in one example) can be counted or otherwise determined. The test electrode is then rated at 30 (FIG. 1 above) according to the ratio of the number of visually discernable pores 188 in the second weld bead 180 divided by the test weld length L. In the exemplary test weld 180 of FIG. 9C, for instance, the rating is determined as the number 9 pores 188 divided by the test weld length L, whereby the electrode rating is essentially independent of the length of test weld created. In this manner, the rating is objective and essentially decoupled from porosity factors associated with the welding operations, operator, and other factors, whereby the rating value for a given tested electrode 120 is primarily a function of the electrode properties. In addition, a number of different electrodes can be tested and rated as described above, where the resulting ratings can be compared or ranked (e.g., with lower numbers indicating superior porosity performance), by which an informed decision can be made as to which electrodes are acceptable for a given application and which electrode and/or electrode manufacturer is the best.

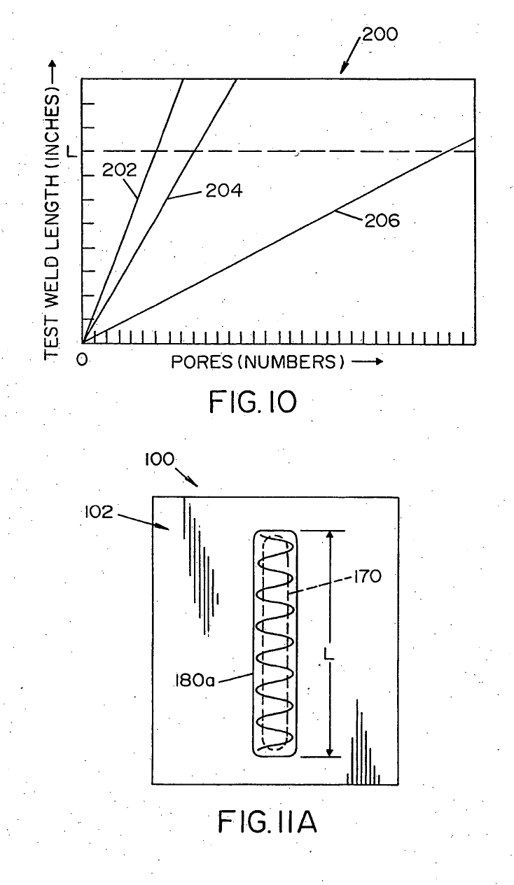

Referring also to FIGS. 10 and 11A-11C, a plot 200 is shown in FIG. 10 illustrating various exemplary porosity performance curves 202, 204, and 206 plotted as the number of visible pores 188 vs. test weld length L, where the illustrated curves are generally straight lines each corresponding to a constant value for a ratio of number of pores per unit test weld length. In one possible situation, a known acceptable electrode can be designated as a comparison standard, and the above testing is used to ascertain the porosity performance of the comparison standard (e.g., in terms of the number of pores per unit length). For example, this may correspond to the illustrated curve 206, wherein subsequent testing and ranking of different stick welding electrodes as described above may indicate ratings that fall above and/or below the acceptance criteria curve 206. In this case, electrode ratings below the acceptance curve 206 have worse porosity characteristics than the designated standard and may therefore be deemed unacceptable for a welding application of interest. On the other hand, tests indicating a rating on the curve 206 can be assumed to provide porosity characteristics commensurate with that of the designated standard electrode, and such tested electrodes may be deemed equivalent or interchangeable with regard to porosity. Furthermore, electrodes having ratings above the curve 206 have superior porosity performance, and therefore can be used in a process for which the designated standard has been found acceptable. For a different welding operation of interest, there may be more stringent requirements with respect to porosity, for example, where only lower amounts of porosity are acceptable. In such cases, a higher threshold acceptance curve 204 or 202 may be used to decide whether a given tested electrode can be used (e.g., whether the tested electrode passes or fails the test). Furthermore, where several electrodes have been tested and rated, the rating values can be compared to one another, by which the electrodes can be objectively ranked with respect to porosity.

As shown in FIGS. 11A-11C, moreover, various different tested electrodes will yield different resulting test welds with respect to porosity, where each of the illustrated test welds 180 are of essentially the same length W and width. In FIG. 11A, a first situation is shown for a very good tested electrode 120, in which a test weld 180a is formed by the above described double pass cap test techniques having a length L, wherein no visible pores are found in the test weld 180a. In this case, the electrode rating would be zero since no pores 188 are discernable by visual or other optical inspection. Using the above situation in which the curve 204 in FIG. 10 represents an acceptable electrode porosity performance, the electrode used in creating the test weld 180a in FIG. 11A would be acceptable, and indeed would be an improvement. Another example is shown in FIG. 11B, wherein six pores 188 are visible in a test weld 180b of length L, corresponding to the curve 202 in FIG. 10. Again, this tested electrode would be accepted according to the acceptance criteria curve 204. FIG. 11C shows yet another example, in which a relatively poor electrode is tested to create a test weld 180c of length L, corresponding to the curve 206 in FIG. 10, where this electrode is inferior with regard to porosity. The invention thus allows differentiation between different electrodes with respect to porosity, and may also be employed in tracking manufacturing variances to ascertain whether a sampled electrode is acceptable according to some predefined porosity acceptance criteria.

Referring now to FIGS. 12, 13A, and 13B, FIG. 12 shows another embodiment in which solid or cored electrodes 200 are evaluated using the method 2 of FIGS. 1 and 2 above. In this implementation, the vertical-down bead-on-plate welding system includes power source 150 with terminal 151 coupled to workpiece 100 and a second output coupled to tested electrode 200 via a contact 280, wherein electrode 200 is fed from a supply spool or reel 250 to the weld joint using one or more rollers 260 driven by a motor 270. Referring also to FIGS. 13A and 13B, any type of welding electrodes 200 may be tested using the methods of the invention, for example, solid electrodes 200a (FIG. 13A) comprising a solid electrode material 210 with or without an optional outer coating 220. Another suitable electrode 200b is shown in FIG. 13B, in this case a cored type electrode 200b having a metallic outer sheath 230 surrounding an inner core 240, where the core 240 includes granular and/or powder flux material (flux core) for providing a shielding gas and protective slag to protect a molten weld pool during the dual fillet welding, alone or in combination with alloying materials (metal core) to set the material composition of the weld material. As with the above-described stick electrode embodiment, the electrodes 200 are tested generally in accordance with the method 2, wherein power source 150 creates a welding signal voltage between the electrode 200 and the workpiece 100 to create a welding arc 154 to melt the end of electrode 120 as well as a portion of workpiece surface 102, thereby creating molten weld material 160 on the workpiece surface 102, together with first slag 162 that solidifies over the molten material 160 and the resulting solidified first weld bead 170. As described above with respect to FIG. 2, one suitable implementation involves forming a substantially straight first bead 170 having a first length L1 of about six inches or more which is about an inch or more away from a nearest workpiece edge 110 with a width W1 (FIG. 6C) approximately twice the diameter of the test electrode 200. Electrode 120 is maintained at a relatively constant angle φ (FIG. 12) relative to the generally vertical workpiece surface 102 during the welding operation, wherein the welding apparatus may be automated or mechanized so as to provide for a relatively constant wire feed speed (motor 270 speed) while maintaining the angle φ substantially constant. The welding parameters can be selected to provide a controlled amount of weld penetration into surface 102 and a repeatable corner profile along longitudinal sides of weld bead 170, wherein the performance of the method 2 is generally as described above except that the test electrode 200 is now fed from the reel 250 rather than manual feeding of a stick electrode 120. In the first pass, little or no lateral weaving is used, in order to create the first weld bead 170 with relatively pronounced corners 170a, 170b as exemplified above in FIG. 6B, and after cooling, the standardized first slag removal operation is performed, as described in connection with FIGS. 2 and 7A above. A standardized second vertical-down welding operation is then performed (e.g., 16 in FIG. 2 above) using the same test electrode or electrode type 200 to create a second weld bead 180 (FIGS. 8A-9C above) extending over the first weld bead 170 and over any remaining first slag 162 in the corners of the first bead 170, where the second vertical-down weld operation preferably includes weaving as shown in FIG. 8A such that the second bead 180 extends laterally beyond the sides of first bead 170. A standardized second slag removal operation is then undertaken (e.g., 18 in FIG. 2, FIG. 9A above) to remove substantially all of the second slag 182 and exposing any surface pores 188 in weld 180 to visual inspection (FIGS. 9B and 9C). The number of visible pores 188 in the second weld bead 180 is then determined as previously described in connection with step 20 of FIG. 2, and the test electrode is rated (e.g., 30 in FIG. 1) according to the ratio of the number of visually discernable pores 188 in the second weld bead 180 divided by the test weld length L.

The invention has been illustrated and described with respect to one or more exemplary implementations or embodiments, although equivalent alterations and modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

Having thus described the invention, the following is claimed:

1. A method for rating a welding electrode for use in welding operations, said method comprising:
providing a test electrode and a workpiece with a substantially flat surface;
orienting said workpiece upright with said surface substantially vertical;
performing a standardized vertical-down double cap pass welding procedure using said test electrode to create a test weld extending along a longitudinal direction on said workpiece surface; and
rating said test electrode according to a number of visible pores in said test weld and according to a length of said test weld.

2. A method as defined in claim 1, wherein performing said standardized vertical-down double cap pass welding procedure comprises:
performing a standardized first vertical-down bead-on-plate welding operation using said test electrode to create a substantially straight first weld bead on said workpiece surface, as well as first slag formed on an outer surface of said first weld bead;
performing a standardized first slag removal operation to expose an upper portion of said first weld bead while leaving some of said first slag remaining along at least one longitudinal side of said first weld bead;
performing a standardized second vertical-down welding operation using said test electrode to create a second weld bead extending over said first weld bead and over said remaining first slag, said second welding operation also creating a second slag formed on an outer surface of said second weld bead;
performing a standardized second slag removal operation to remove substantially all of said second slag; and
determining said number of visible pores in said second weld bead.

3. A method as defined in claim 2, wherein performing said second vertical-down welding operation comprises weaving said test electrode laterally to create said second weld bead as a serpentine bead.

4. A method as defined in claim 1, wherein said test electrode is a cellulosic stick electrode.

5. A method as defined in claim 2, wherein said test electrode is a solid electrode.

6. A method as defined in claim 1, wherein said test electrode is a coredelectrode.

7. A method as defined in claim 6, wherein said test electrode is rated according to the ratio of said number of visible pores in said test weld divided by said length of said test weld.

8. A method as defined in claim 5, wherein said test electrode is rated according to the ratio of said number of visible pores in said test weld divided by said length of said test weld.

9. A method as defined in claim 4, wherein said test electrode is rated according to the ratio of said number of visible pores in said test weld divided by said length of said test weld.

10. A method as defined in claim 3, wherein said test electrode is rated according to the ratio of said number of visible pores in said test weld divided by said length of said test weld.

11. A method as defined in claim 2, wherein said test electrode is rated according to the ratio of said number of visible pores in said test weld divided by said length of said test weld.

12. A method as defined in claim 1, wherein said test electrode is rated according to the ratio of said number of visible pores in said test weld divided by said length of said test weld.

13. A method as defined in claim 12, wherein said test weld extends along said longitudinal direction for a length of about six inches or more.

14. A method as defined in claim 6, wherein said test weld extends along said longitudinal direction for a length of about six inches or more.

15. A method as defined in claim 3, wherein said test weld extends along said longitudinal direction for a length of about six inches or more.

16. A method as defined in claim 2, wherein said test weld extends along said longitudinal direction for a length of about six inches or more.

17. A method as defined in claim 1, wherein said test weld extends along said longitudinal direction for a length of about six inches or more.

18. A method as defined in claim 17, wherein said test weld is created about one inch or more away from a nearest edge of said workpiece.

19. A method as defined in claim 12, wherein said test weld is created about one inch or more away from a nearest edge of said workpiece.

20. A method as defined in claim 6, wherein said test weld is created about one inch or more away from a nearest edge of said workpiece.

21. A method as defined in claim 3, wherein said test weld is created about one inch or more away from a nearest edge of said workpiece.

22. A method as defined in claim 2, wherein said test weld is created about one inch or more away from a nearest edge of said workpiece.

23. A method as defined in claim 1, wherein said test weld is created about one inch or more away from a nearest edge of said workpiece.
